(19) United States
(12) Patent Application Publication
(10) Pub. No.: US 2009/0193940 A1
(43) Pub. Date: Aug. 6, 2009

(54) JAW PIPE WRENCH WITH RESILIENT MEMBER

(76) Inventor: Shao-Fan Kuo, Taishan Hsiang (TW)

Correspondence Address: SINORICA, LLC, 2275 Research Blvd., Suite 500, ROCKVILLE, MD, 20850, US

(21) Appl. No.: 12/025,498

(22) Filed: Feb. 4, 2008

(51) Int. Cl. B25B 13/12

(52) U.S. Cl. 81/145; 81/142

(57) ABSTRACT

The present invention pertains to a jaw pipe wrench with resilient member comprising a wrench body penetrating through an actuating jaw, where a resilient member mounted and provides with one flat surface leans against said wrench body, so as to drive a serrated section of the wrench body firmly contacting with a serrated section of actuating jaw. While in manipulation, users initially propel the actuating jaw and synchronically compress the resilient member, the serrated section of the wrench body thus moves away from the serrated section of the actuating jaw, whereby users can freely raise or descend the actuating jaw in time of clamping, thus increasing the convenience of using.

### BACKGROUND OF THE INVENTION

1. Field of the Invention

The present invention relates to a wrench tool, in particularly a jaw pipe wrench with resilient member.

2. Description of the Related Art

Generally, a conventional wrench often provides with a fastener, e.g. a screw, for screwing an upper jaw and a lower jaw, and users used to rotate the screw for adjusting the space between the two jaws. In practical, users need to have both hands grip the handle and simultaneously free the screw, further, the screw used to have small pitch for ensuring the gripping capability of the wrench. In this manner, users need to spend more time loosening the screw and adjusting the space of two jaws, thus increasing the inconvenience of using.

In view of the above problem, another conventional wrench relies on a toothlike element between the two jaws as disclosed in U.S. Pat. No. 6,938,525, namely, users simply press the brake lever for temporarily moving the toothlike elements away from the lower jaw, thereby urging the jaw upward and downward; however, the lower jaw and the brake lever are separately arranged, and a spring is captured by the brake lever for ensuring a resilience, which may result of the increasing of the manufacturing cost and the complicate concatenation of elements. Furthermore, the wrench needs to be used by pressing the brake lever for adjusting the space between the jaws, the position of the brake lever thus needs consideration; that is, if the brake lever is just arranged in an improper place, it would not be facilely touched by users, thus the wrench still lacks of convenience in use.

Additionally, the upper and the lower jaws are also susceptible to wrench body with various shapes, for instance formed of square or circular configurations, and the jaws may not be in optimum fit therewith. In this manner, the wrench can not steadily clamp objects and hence wasting time in operation.

### SUMMARY OF THE INVENTION

With regard to the above problems, the object of the present invention is to provide a jaw pipe wrench with resilient member which facilitates to increase the convenience of using, and reduce a complicate concatenation of elements and the manufacturing time and cost, thus increasing the competition of products.

The jaw pipe wrench in accordance with the present invention mainly comprises a wrench body, a handle, an actuating jaw, and a pivotal jaw; wherein, the body and the actuating jaw have respective serrated sections which can fit with each other so as to ensure a good clamping stability while the two jaws grip the object. Particularly, a resilient member disposed within the actuating jaw provides with one flat surface propped against the wrench body; while propelling the actuating jaw, the resilient member is simultaneously compressed to render the wrench body moving away from the jaw, whereby users can facilely raise or descend the actuating jaw by one hand for adjusting the space between the actuating jaw and the pivotal jaw, thus increasing the convenience of using. Further, the resilient member does not need a complicate combination, thereby saving the manufacturing time and cost.

Moreover, the third serrated section of the actuating jaw formed of an arcuate contour mainly comprises a respective first auxiliary surface at both sides thereof, and each faces to a second auxiliary surface of the jaw portion. In use, the object formed of the circular or polygonal shape readily fits with the third arcuate serrated section and is subsequently firmly clamped between the two jaws by adjusting movements of the actuating jaw, so as to decrease the problem of loosening. Consequently, the present invention also facilitates to adapt for various shapes of objects and increase the clamping capability.

The advantages of the present invention over the known prior arts will become more apparent to those of ordinary skilled in the art by reading the following descriptions with the relating drawings.

### BRIEF DESCRIPTION OF THE DRAWINGS

FIG. 1 is a perspective view showing a first preferred embodiment of the present invention;

FIG. 2 is an exploded view showing the first preferred embodiment of the present invention;

FIG. 3 is an exploded view showing the first preferred embodiment of the present invention;

FIG. 4 is a schematic view showing the first preferred embodiment in time of manipulation;

FIG. 5 is a schematic view showing the first preferred embodiment in time of manipulation;

FIG. 6 is a partial enlarged view showing the resilient member of the present invention;

FIG. 7 is an exploded view showing a second preferred embodiment of the present invention;

FIG. 8 is a perspective view showing the concatenation of elements disclosed in FIG. 7;

FIG. 9 is a schematic view showing the second preferred embodiment in time of operation; and

FIG. 10 is a schematic view showing the second preferred embodiment in time of operation.

### DETAILED DESCRIPTION OF THE PREFERRED EMBODIMENTS

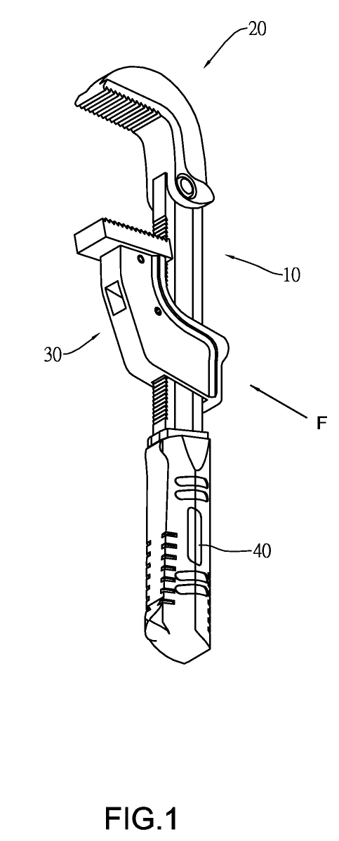

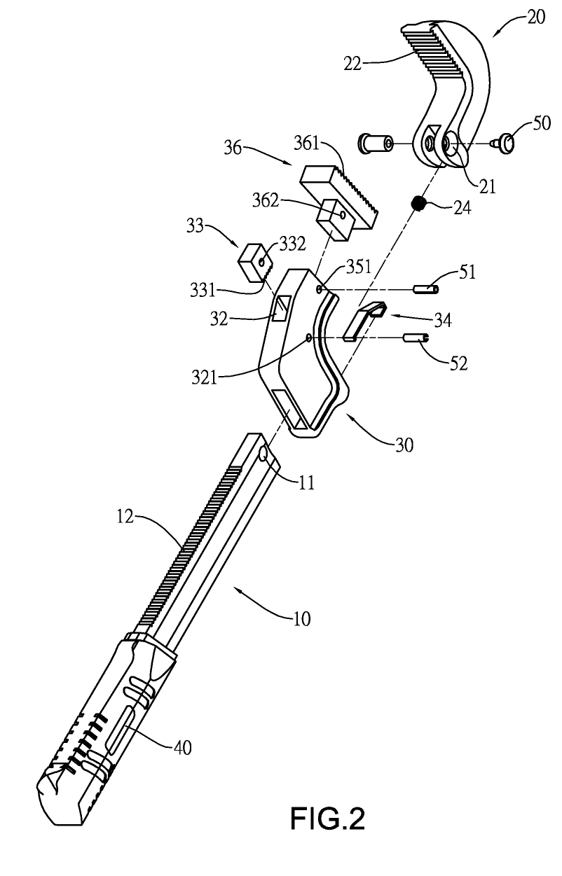

Referring to FIG. 1 and 2, a first preferred embodiment of the present invention comprises a wrench body 10, a pivotal jaw 20 pivoted to a top end of the wrench body 10, an actuating jaw 30 disposed on the wrench body 10, and a handle 40 engaged to a distal end of the wrench body 10, opposite to the pivotal jaw 20; wherein, the wrench body 10 includes a first bore 11 disposed at the top end thereof and a first serrated section 12 disposed at one side thereof; further, the pivotal jaw 20, which can be formed in an arcuate shape, comprises a second bore 21 disposed at a distal end thereof and a third serrated section 22 disposed opposite to the second bore 21; wherein the second bore 21 is in contact with the first bore 11 so as to firmly fasten the pivotal jaw 20 to the wrench body 10 by screwing a first pivot pin 50 through the two bores 21-11. The first pivot pin 50 here is adopted in a cooperation of male and female screws.

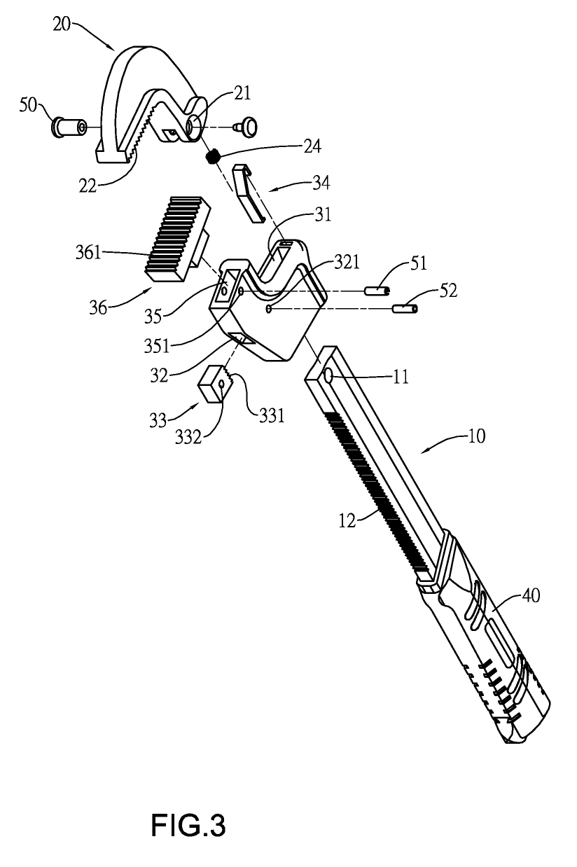

Still further, referring to FIG. 3, the actuating jaw 30 provides with an opening 31 arranged thereon for the wrench body 10 to penetrate therein, a first trough 32 disposed at one side thereof and transversely contacting with the opening 31, an insertion 33 put into the first trough 32, and a resilient member 34 disposed within the actuating jaw 30; wherein, the insertion 33 has a second serrated section 331 arranged at one side thereof, and the resilient member 34 mounted inside the actuating jaw 30 and propped against the wrench body 10, so as to propel the first serrated section 12 of the wrench body 10 fit with the second serrated section 331. That is, the first serrated section 12 is separated from the second serrated section 331 under a force F imparted thereto, which further results of the actuating jaw 30 sliding on the wrench body 10; in contract, the actuating jaw 30 is back to its original position while pausing the force F for in turn engaging the second serrated section 331 and the first serrated section 12.

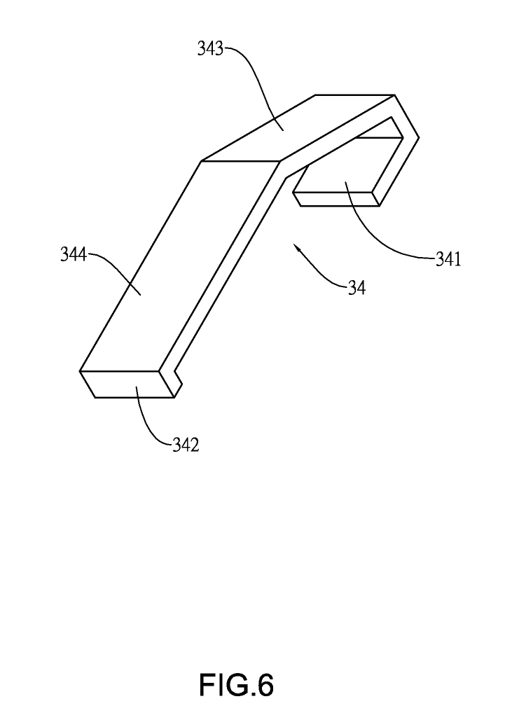

Moreover, the resilient member 34 (as shown in FIG. 6) can provide with a curved portion 341, a protrusion 342, a first flat surface 343, and a second flat surface 344; wherein, the two flat surfaces 343-344 intersect to configure in a “<” shape, and the curved portion 341 and the protrusion 342 respectively connects to the first flat surface 343 and the second flat surface 344. Further, the resilient member 34 can also be a spring or other proper materials with springiness, and the first serrated section 12 and the second serrated section 331 are adopted to be inclined toward single orientation. The single orientation of the two serrated sections 12-331 can efficiently resist the downward movement of the actuating jaw 30 while gripping and further rotating the object, thereby not only making the two serrated sections 12-331 well fit with each other but also increasing the loading capability.

Continuing with the aforementioned, referring to FIGS. 2 and 3, the actuating jaw 30 has a second trough 35 arranged on a top end thereof for a jaw portion 36 to be inserted in and a third bore 351 disposed on both sides of the second trough 35, and the jaw portion 36 includes a fourth serrated surface 361 defined thereon to face the third serrated surface 22 of the pivotal jaw 22 and a fourth bore 362 arranged on both sides thereof. The third bore 351 can contact with the forth bore 362 and a second pivot pin 51 is screwed therethrough so as to fasten the jaw portion 36 into the second trough 35. In this manner, a certain amount of friction occurs between the third and fourth serrated sections 361-22 and prevents the object from being facilely loosened in operation, thus efficiently and steadily grip the object therebetween. Additionally, the first trough 32 has a fifth bore 321 defined on both sides thereof, and the insertion 33 also includes a sixth bore 332 disposed on both sides thereof; a third pivot pin 52 would be screwed through both the bores 321-332 thereby securing the insertion 33 into the first trough 32. Both the second pivot pin 51 and the third pivot 52 pin are presented as C-ring shapes in the preferred embodiment of the present invention.

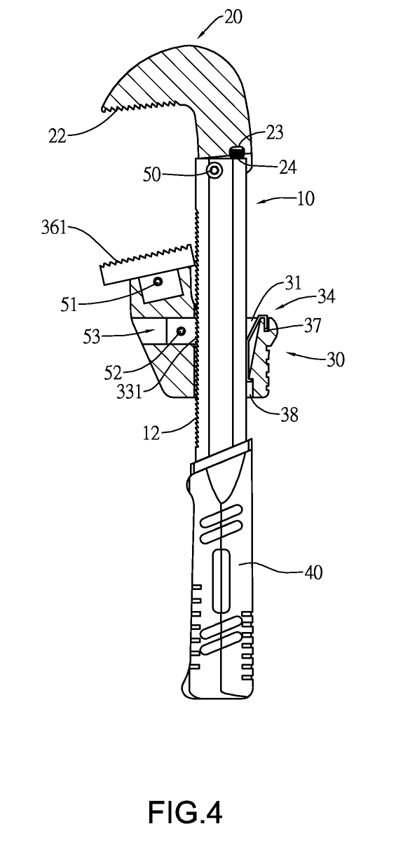

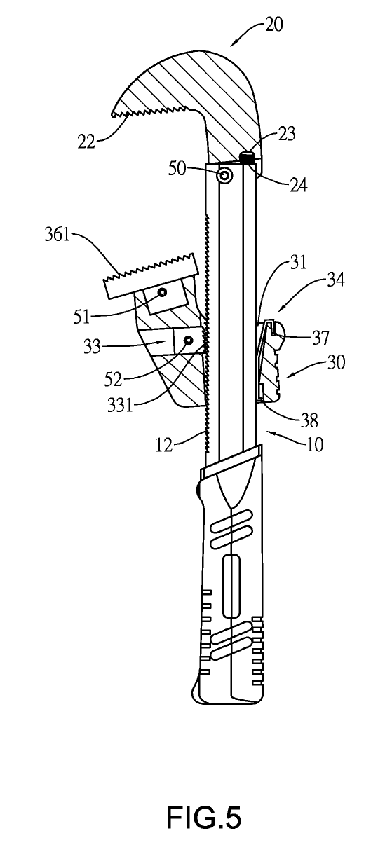

Referring to FIGS. 4 and 6, the pivotal jaw 20 has a third trough 23 defined adjacent the second bore 21 (not labeled in FIG. 4), where a spring 24 is mounted for ensuring a substantial clamping in manipulation; the actuating jaw 30 further includes respective concavity 37 and flute 38 defined therein, and the flute 38 is in contact with the opening 31. In a concatenation of the elements, the curved portion 341 of the resilient member 34 is arranged to insert into the concavity 37 and the protrusion 342 thereof is propped against a top end of the flute 38. Additionally, the resilient member 34 with its second flat surface 344 leans against the wrench body 10 since the body 10 penetrates through opening 31, which results in that the first serrated section 12 of the wrench body 10 well fits with the second serrated section 331 of the insertion 33 (as shown in FIG. 4). Further referring to FIG. 5, while in manipulation, users merely hold the handle 40 by one hand and push or pull the actuating jaw 30 by their thumbs, simultaneously the resilient member 34 become compressed by the wrench body 10, so that the second flat surface 344 is lengthened to render the protrusion 38 downwardly slipping along the flute 38, and the curved portion 341 still interposes in the concavity 37. Thus, the first serrated section 12 deviates from the second serrated section 331, and further the actuating jaw 30 can freely move upwardly or downwardly for adjusting the space between the actuating jaw 30 and the pivotal jaw 20. Subsequently, while stopping the driving the actuating jaw 30, the protrusion 342 springs back to the former position and propels the body 10, thereby reversely making the first serrated section 12 contact with the second serrated section 331.

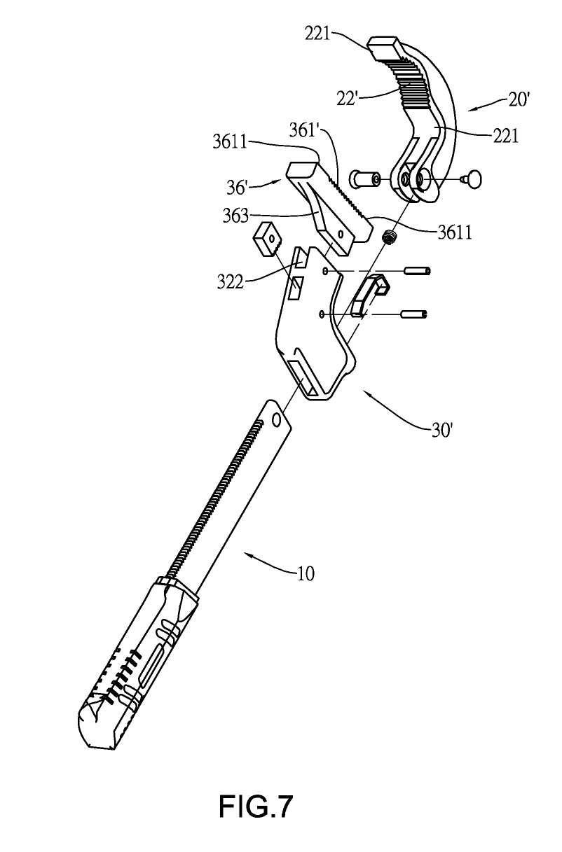

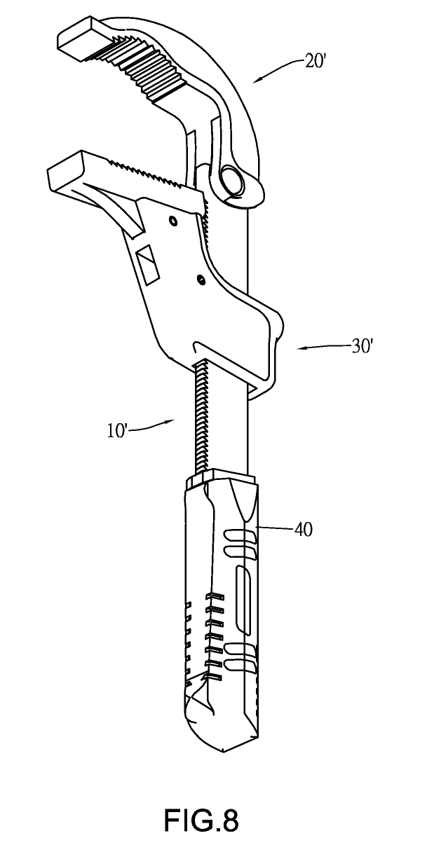

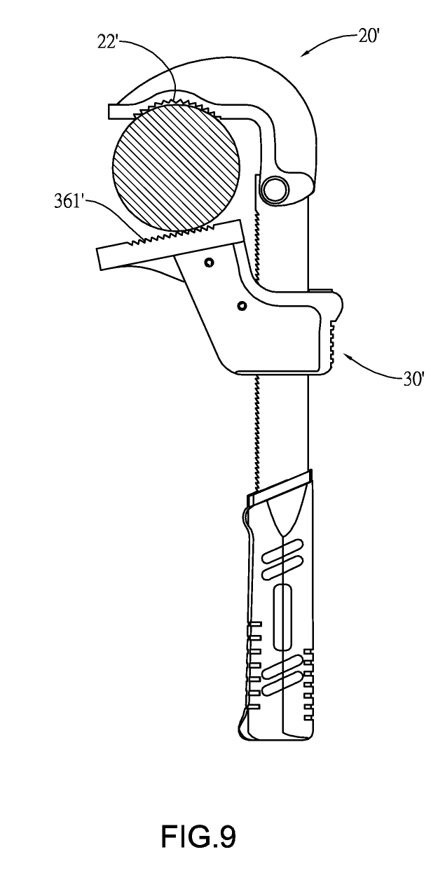

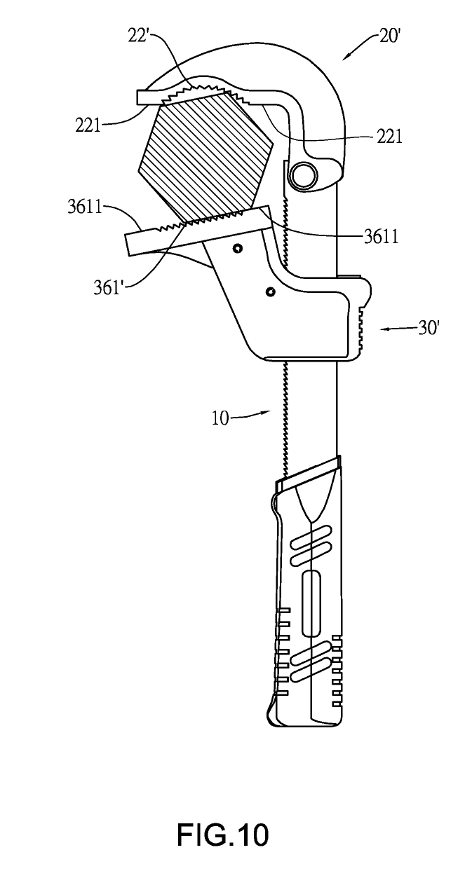

Referring to FIGS. 7 and 8, a second preferred embodiment of the present invention includes the elements and operations similar to the first embodiment. Particularly, the pivotal jaw 20′ has a third serrated section 22′ formed of an arcuate shape and comprises a respective first auxiliary surface 221 at both sides of the third serrated section 22′; further the jaw portion 36′ also has a second auxiliary surface 3611 respectively arranged beside the fourth serrated section 361′; wherein, a socket 322 is arranged on the actuating jaw 30′ and communicates with the second trough 35 (not labeled in this figure), by which a supporting portion 363 protruded from the underside of the jaw portion 36′ leans against the socket 322 while inserting the jaw portion 36′ into the second trough 35. Therefore, the supporting portion 363 with longer length enlarges the loading area and reduces the stress concentrated on the fourth serrated section 361′. While in use, the object formed with a circular contour (shown in FIG. 9) or with a polygonal shape (shown in FIG. 10) can be firmly and steadily gripped between the pivotal jaw 20′ and the actuating jaw 30′, thus strengthening the clamping capability.

To sum up, the present invention takes advantages of the resilient member mounted within the actuating jaw and having one flat surface propped against the wrench body, so as to promote the serrated section of the wrench body to contact with the serrated section of actuating jaw while not in use or move away therefrom for adjusting the space between the two jaws, thus increasing the convenience of using. Additionally, the resilient member mounted inside the actuating jaw also decreases the complicate concatenation of elements and the manufacturing time and cost as well.

While we have shown and described the embodiment in accordance with the present invention, it should be clear to those skilled in the art that further embodiments may be made without departing from the scope of the present invention.

I claim:

1. A jaw pipe wrench with resilient member comprising:
a wrench body; wherein, said wrench body including a first bore disposed at a top end thereof and a first serrated section at one side thereof;
a handle engaged to a distal end of said wrench body, opposite to said first bore;
an actuating jaw disposed on said wrench body; wherein, said actuating jaw having an opening arranged thereon for being penetrated by said wrench body, a first trough disposed at one side thereof and transversely contacting with said opening, an insertion put into said first trough and having a second serrated section arranged at one side thereof, and a resilient member disposed inside said actuating jaw and propped against said wrench body, so as to propel said first serrated section of said wrench body fit with said second serrated section of said actuating jaw;
a pivotal jaw formed in an arcuate shape pivoted to said wrench body; wherein, said pivotal jaw comprising a second bore disposed at a distal end thereof, and a third serrated section disposed opposite to said second bore; said second bore contacting with said first bore by a first pivot pin so as to secure said pivotal jaw to said wrench body;

2. The wrench as claimed in claim 1, wherein, said actuating jaw includes respective concavity and flute defined therein, and said flute is in contact with said opening.

3. The wrench as claimed in claim 2, wherein, said resilient member includes a first flat surface and a second flat surface connecting thereto, so that said two flat surfaces intersect to configure in a “<” shape, and said second flat surface is propped against said wrench body.

4. The wrench as claimed in claim 3, wherein, said resilient member has a curved portion for being inserted into said concavity and a protrusion for leaning against said flute.

5. The wrench as claimed in claim 4, wherein, said curved portion connects to said first flat surface and said protrusion engages to said second flat surface.

6. The wrench as claimed in claim 1, wherein, said actuating jaw has a second trough arranged on a top end thereof, where a jaw portion can enter; said jaw portion includes a fourth serrated surface defined thereon, facing said third serrated surface of said pivotal jaw.

7. The wrench as claimed in claim 6, wherein, said third serrated surface is formed in an arcuate contour.

8. The wrench as claimed in claim 6, wherein, said second trough has a third bore disposed on both sides thereof, and said jaw portion also includes a fourth bore defined on both sides thereof; said third bore can be in contact with said fourth bore, thereby fastening said jaw portion into said second trough by screwing a second pivot pin through said third and said forth bores.

9. The wrench as claimed in claim 8, wherein, said second pivot pin can be arranged as C-ring shapes.

10. The wrench as claimed in claim 1, wherein, said first trough has a fifth bore defined on both sides thereof, and said insertion also includes a sixth bore disposed on both sides thereof; said fifth bore can be in contact with said sixth bore, thereby fastening said insertion into said first trough by screwing a third pivot pin through said fifth and said sixth bores.

11. The wrench as claimed in claim 10, wherein, said third pivot pin can be arranged as C-ring shapes.

12. The wrench as claimed in claim 1, wherein, said pivotal jaw has a third trough defined adjacent to said second bore, and said third trough includes a spring mounted therein.

13. The wrench as claimed in claim 1, wherein, said first serrated section and said second serrated section are inclined toward single orientation, so as to render said first serrated section well fit with said second serrated section.

14. The wrench as claimed in claim 1, wherein, said first pivot pin can be presented in a cooperation of male and female screws.

15. The wrench as claimed in claim 1, wherein, said resilient member can be a spring.

16. An integral resilient member for inserting into an actuating jaw comprising:
a first flat surface;
a second flat surface connecting thereto; wherein said two flat surfaces intersect to configure in a “<” shape;
a curved portion attaching to said first flat surface; and
a protrusion engaging to said second flat surface.
